(19) United States
(12) Patent Application Publication
(10) Pub. No.: US 2007/0251148 A1
(43) Pub. Date: Nov. 1, 2007

(54) Window Regulator

(76) Inventors: Jason William Watson, Toronto (CA); T. Carter Hodgins, Ontario (CA); Gary R. Raedts, Ontario (CA); Dan Stefan, Ontario (CA)

Correspondence Address: CLARK HILL, P.C., 500 WOODWARD AVENUE, SUITE 3500, DETROIT, MI, 48226, US

(21) Appl. No.: 10/591,685

(22) PCT Filed: Feb. 28, 2005
(86) PCT No.: PCT/CA05/00289

§ 371 Date: May 21, 2007

Related U.S. Application Data
(60) Provisional application No. 60/550,115, filed on Mar. 4, 2004.

(51) Int. Cl. E05F 11/48

(52) U.S. Cl. 49/352

(57) ABSTRACT

A window regulator wherein the drive means can be pivoted, during assembly, to move the centers of the driven drum and a guide closer together to provide for easy routing of the flexible drive member and can then be moved apart to tension the flexible drive member to complete the assembly. The regulator can be a single rail regulator or a dual rail regulator and the flexible drive member can be a belt, wire cable or other suitable device.

### FIELD OF THE INVENTION

The present invention relates to window regulators for vehicles. More specifically, the present invention relates to a power operated window regulator.

### BACKGROUND OF THE INVENTION

Window regulators are well known and are employed in many vehicles to provide window opening and closing mechanisms that are power operated. Typically a DC electric motor operates the window and, if it is desired to also allow manual operation of the window, a clutch mechanism may also be provided to disengage the motor and allow a crank to move the window between open and closed positions.

Window regulators are typically single or double rail designs wherein the window to be moved is attached to a liftplate moveable along the rail and which is driven by a flexible drive member, such as a belt or cable. Typically, the motor and/or clutch (if present) assembly drives the belt or cable over pulleys or guides at the ends of the rails and thus moves the liftplate up or down the rail as desired.

Recently, in an attempt to reduce the number of components and/or to reduce the overall size of the regulator assembly, designs have been made wherein the motor and clutch assembly has been located at the end of one of the rails with the drum driven by the motor replacing the pulley which would otherwise be required at that location. Examples of such systems include U.S. Pat. No. 5,799,441 to Shibata; U.S. Pat. No. 6,088,965 to Fukumoto et al.; and U.S. Pat. No. 6,115,966 to Shibata.

While such systems have provided advantages over prior art systems, they still suffer from some disadvantages. In particular, it is desired that the cables and/or belts employed with window regulators be well tensioned so that slack is reduced as such slack can otherwise result in improper or difficult operation of the window and/or undue wear of the regulator mechanism. In the prior art systems, the need to properly tension the drive cables or belts has either not been well met, or has increased the difficulty of assembly of the window regulators, and thus their costs.

### SUMMARY OF THE INVENTION

It is an object of the present invention to provide a novel window regulator which obviates or mitigates a disadvantage of the prior art.

According to a first aspect of the present invention, there is provided a window regulator comprising: at least one lift plate to which a window can be affixed; at least one rail along which said at least one lift plate can be moved, the rail including a guide located adjacent one end and a drive means located adjacent the opposite end, the drive means including a driven drum driven by said drive means; and a flexible drive member extending about said driven drum and said guide and connected to said lift plate such that movement of said driven drum moves said lift plate along the at least one rail via said flexible drive member and wherein said drive means and said driven drum are pivotally mounted to said rail to allow said driven drum to be moved away from said guide to tension said flexible drive member.

Preferably, the flexible drive member is a belt or a wire cable.

In another aspect of the present invention, there is provided, in a window regulator having a drive means including a driven drum engaging a flexible drive member that is connected to a lift plate, wherein the flexible drive member is routed about a guide mounted to one end of a rail, an improvement comprising pivotally mounting the drive means to an opposite end of the rail.

In yet another aspect of the present invention, there is provided a window regulator comprising: at least one rail; a flexible drive member; at least one lift plate connected to the flexible drive member; at least one guide mounted to the at least one rail for routing the flexible drive member; and drive means including a driven drum engaging the flexible drive member, wherein the drive means is pivotally mounted to the at least one rail to allow the driven drum to be moved in relation to the at least one guide in order to tension the flexible drive member.

The present invention provides a window regulator wherein the drive means can be pivoted, during assembly, to move the centers of the driven drum and a guide for the flexible drive member closer together to provide for easy routing of the flexible drive member and can then be moved apart to tension the flexible drive member to complete the assembly. The regulator can be a single rail regulator or a dual rail regulator, the flexible drive member can be a belt, wire cable or other suitable device and the guide can be a pulley or other suitable mechanism for redirecting the flexible drive member.

### BRIEF DESCRIPTION OF THE DRAWINGS

Preferred embodiments of the present invention will now be described, by way of example only, with reference to the attached Figures, wherein:

FIG. 1 shows a front view of a single rail window regulator in accordance with an embodiment of the present invention;

FIG. 2 is an end view of the bottom of the window regulator of FIG. 1 showing the attachment of a drive means to a rail of the regulator;

FIG. 3a shows the rail and drive means of the window regulator of FIG. 1 in an assembly position; and

FIG. 3b shows the rail and drive means of the window regulator of FIG. 1 in an assembled position.

### DETAILED DESCRIPTION OF THE INVENTION

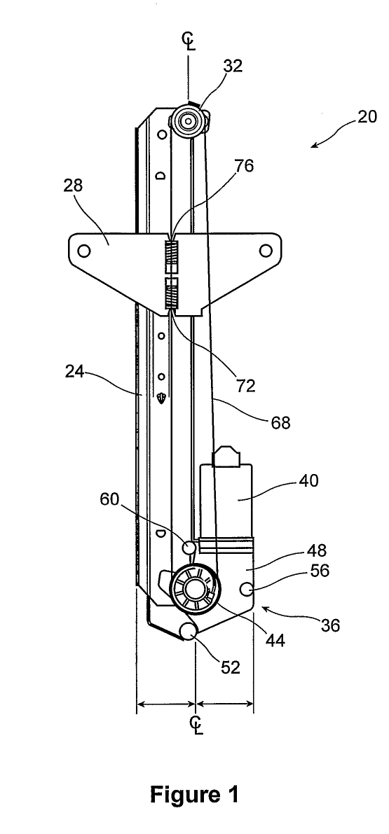

A single rail window regulator in accordance with an embodiment of the present invention is indicated generally at 20 in FIG. 1. Regulator 20 includes a rail 24 along at least a portion of the length of which a lift plate 28 can slide. A guide, in the illustrated embodiment a pulley 32, is mounted adjacent one end of rail 24. At the end of rail 24 opposite pulley 32, a drive means 36 is located, drive means 36 comprising a direct current motor 40 and a driven drum 44 which can be turned in a clockwise or counter clockwise direction by operation of motor 40 is a respective direction.

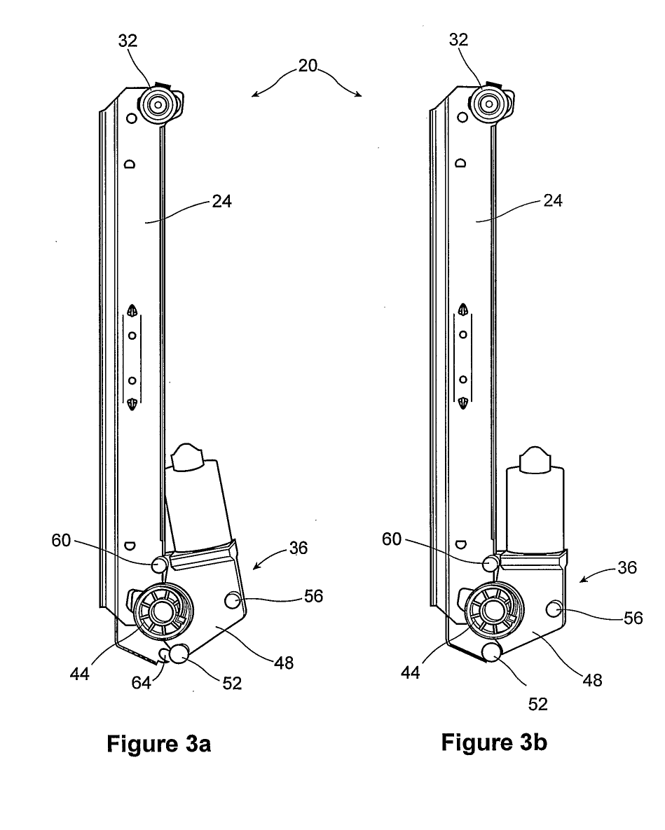

Driven drum 44 can be connected to motor 40 by any suitable means, such as a gear train and/or a clutch mechanism, as will be apparent to those of skill in the art and the housing 48 for the gear train and/or clutch mechanism includes three bores in or through which mounting bolts 52, 56 and 60 can be received. Bolt 60 extends through rail 24 to pivotally connect drive means 36 to rail 24. Bolt 56 can be employed to assist in mounting regulator 20 within a vehicle and bolt 52can engage a slot 64 in the end of rail 24, best seen in FIG. 3a, to prevent further pivotal movement of drive means 36 with respect to rail 24 once regulator 20 is assembled.

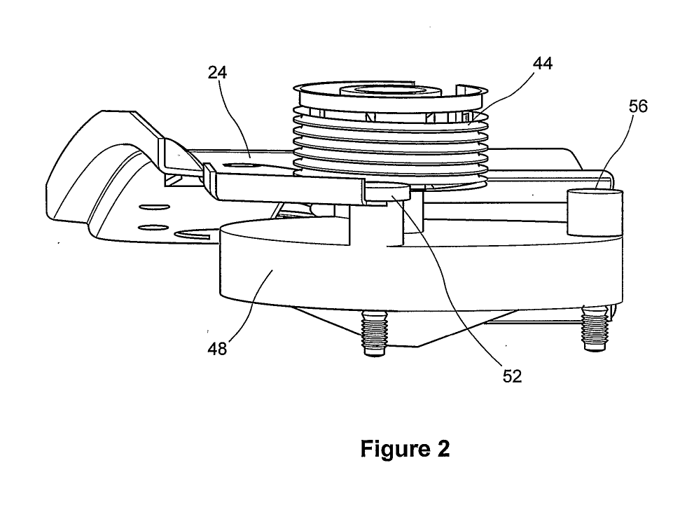

A flexible drive mechanism 68 extends from a first attachment point 72 on lift plate 28 down to driven drum 44 about which it is wrapped and then up to and around pulley 32 and then down to a second attachment point 76 on lift plate 28. In the illustrated embodiment, flexible drive member 68 is a wire cable and a driven drum 44 suitable for use with such a wire cable is shown in FIG. 2. Configurations of driven drum 44 and pulley 32 which are suitable for other flexible drive member 68, such as belts, will be apparent to those of skill in the art. Further, rather than a pulley 32, the guide for flexible drive member 68 can be any suitable device about which flexible drive member 68 can move. Suitable guides for wire cables can include a Delrin™ disc with grooves in its perimeter edge, the wire cable sliding through the groove around the perimeter of the disc when the wire cable is moved.

When regulator 20 is assembled, flexible drive member 68 must be tensioned to remove substantially all of the slack therein as excess slack will increase the rate at which components of regulator 20 wear and/or can permit twisting, wobble or other undesired movement of lift plate 28 during operation of regulator 20. Conventionally, the need to tension the flexible drive member of a regulator has increased the difficulty of and/or time required for assembly of regulators.

In the present invention, flexible drive member 68 is not tensioned at the start of assembly, while it is routed around driven drum 44 and pulley 32 and then to lift plate 28, but must be tensioned thereafter to remove slack. Conventionally, this would require that the assembly person route flexible drive member 68 as discussed above, then connect one end of flexible drive member 68 to lift plate 28, for example at attachment point 72, and then employ a tensioning device to tension flexible drive member 68 and connect the other end of flexible drive member 68 to lift plate 28 at attachment point 76.

However, with the present invention, tensioning is achieved in a simple, yet effective manner. As will be apparent from FIG. 3a, drive means 36 can be pivoted about bolt 60 to the position shown wherein the centers of driven drum 44 and pulley 32 are closer than they are when drive means 36 is in the assembled position, shown in FIG. 3b. When drive means 36 is in the assembly position illustrated in FIG. 3a, the routing of flexible drive member 68 is easily accomplished, as is the rest of the assembly of regulator 20.

Once routing of flexible drive member 68 is achieved, drive means 36 is pivoted about bolt 60 to the assembled position shown in FIG. 3b, which moves the centers of driven drum 44 and pulley 32 farther apart, tensioning flexible drive member 68. As drive means 36 is moved to the position shown in FIG. 3b, bolt 52 enters slot 64 and, when bolt 52 is appropriately tightened with a nut (not shown) or by other suitable means, further pivotal movement of drive means 36 is prevented.

It is contemplated that, if flexible drive member 68 has a preselected length and other components of regulator 20 have sufficiently tight tolerances, slot 64 can have a predetermined length and, once routing of flexible drive member 68 has been completed during assembly, drive means 36 need only be rotated to move bolt 52 to the end of slot 64 to achieve an appropriate tension in flexible drive member 36. However, if is also contemplated that, if there is variability or tolerance in the length of flexible drive member 68 or in other components of regulator 20, then bolt 52 can be placed at an appropriate position along slot 64 to achieve the desired tension in flexible drive member 68 and then tightened to maintain drive means 36 in that position. In this latter case, it is contemplated than housing 48 and rail 24, adjacent slot 64, can be provided with complementary toothed surfaces (not shown) which inter-engage and assist in maintaining bolt 52 in the desired position along slot 64.

As will now be apparent to those of skill in the art, the ability to pivot drive means 36 about bolt 60 to tension flexible drive member 68 is an effective and simple manner to tension flexible drive member 68 and allows for a compact regulator to be constructed. It is also contemplated that the present invention allows flexible drive member 68 to be configured as an endless loop, such as toothed belt or wire cable loop, rather than a length of a belt or wire cable having ends which must be attached during assembly of regulator 20. In this case, flexible drive member 68 would be provided to an assembler as an endless loop of known length and would be routed about driven drum 44 and pulley 32 and would be anchored to lift plate 28 by an appropriate means. Then, flexible drive member 68 would be tensioned, as before, by pivoting drive means 36 to the desired position.

It will also be apparent to those of skill in the art that the present invention can also be employed with dual rail regulators. Typically, in such regulators, a pair of flexible drive members are employed, one to operate the lift plate on each respective rail and driven drum 44 would include a conventional spiral drum section, as used with a single rail regulator such as regulator 20, and a co-axial but axially spaced guide portion. One flexible drive member engages the spiral drum portion and the other engages the guide portion. The flexible drive member which services the distal rail to which the drive means is not connected may pass through a pair of conduits extending between the drive means and the distal rail, the conduits cooperating to transfer the tension of the flexible drive member between the rails.

The above-described embodiments of the invention are intended to be examples of the present invention and alterations and modifications may be effected thereto, by those of skill in the art, without departing from the scope of the invention which is defined solely by the claims appended hereto.

We claim:

1. A window regulator comprising:
at least one lift plate to which a window can be affixed; at least one rail along which said at least one lift plate can be moved, the rail including a guide located adjacent one end and a drive means located adjacent the opposite end, the drive means including a driven drum driven by said drive means;
and a flexible drive member extending about said driven drum and said guide and connected to said lift plate such that movement of said driven drum moves said lift plate along the at least one rail via said flexible drive member and wherein said drive means and said driven drum are pivotally mounted to said rail to allow said driven drum to be moved away from said guide to tension said flexible drive member.

2. The window regulator of claim 1 wherein said flexible drive member is a belt.

3. The window regulator of claim 1 wherein said flexibly drive means is a wire cable.

4. The window regulator of claim 1 wherein said guide is a pulley.

5. The window regulator of claim 1 including first and second rails, each rail having a lift plate to which a respective one of opposed sides of a window can be attached, the first rail including said guide adjacent one end and said drive means and driven drum adjacent said opposite end and the second rail including a guide adjacent each respective end and wherein the flexible drive member extends about a first portion of the driven pulley and the guide of the first rail and a second flexible drive member extends around a second portion of the driven drum and each guide of the second rail such that movement of said driven drum moves each lift plate in the same direction along each respective rail.

6. The window regulator of claim 5 wherein at least one of said guides is a pulley.

7. The window regulator of claim 5 wherein the flexible drive member passes through first and second conduits extending between said first and second rails.

8. The window regulator of claim 5 wherein said driven drum also includes a guide portion.

9. The window regulator of claim 1 including complementary toothed surfaces on said rail and said drive means, said complementary toothed surfaces inter-engaging to maintain said drive means in a desired position wherein said flexible drive member is tensioned to a selected degree.

10. In a window regulator having a drive means including a driven drum engaging a flexible drive member that is connected to a lift plate, wherein the flexible drive member is routed about a guide mounted to one end of a rail, an improvement comprising pivotally mounting the drive means to an opposite end of the rail.

11. A window regulator comprising:
at least one rail;
a flexible drive member;
at least one lift plate connected to the flexible drive member;
at least one guide mounted to the at least one rail for routing the flexible drive member; and
drive means including a driven drum engaging the flexible drive member,
wherein the drive means is pivotally mounted to the at least one rail to allow the driven drum to be moved in relation to the at least one guide in order to tension the flexible drive member.

12. A window regulator comprising:
at least one lift plate to which a window can be affixed;
at least one rail along which said at least one lift plate can be moved, the rail including a guide located adjacent one end and a drive means located adjacent the opposite end, the drive means including a driven drum driven by said drive means;
and a flexible drive member in the form of an endless loop of preselected length, the drive member extending about said driven drum and said guide and connected to said lift plate such that movement of said driven drum moves said lift plate along the at least one rail via said flexible drive member and wherein said drive means and said driven drum are pivotally mounted to said rail to allow said driven drum to be moved away from said guide to tension said flexible drive member.
